(19) United States
(12) Patent Application Publication
(10) Pub. No.: US 2015/0221113 A1
(43) Pub. Date: Aug. 6, 2015

(54) METHOD FOR DYNAMICALLY DISPLAYING PICTURE AFTER CONVERTING GIF PICTURE TO PDF FILE

(71) Applicant: Fujian Foxit Software Development Joint Stock Co., Ltd., Fuzhou (CN)

(72) Inventors: Yuqian Xiong, Fuzhou (CN); Shengen Guo, Fuzhou (CN)

(21) Appl. No.: 14/419,966

(22) PCT Filed: May 21, 2013
(86) PCT No.: PCT/CN2013/000594

§ 371 Date: Feb. 6, 2015

(30) Foreign Application Priority Data
Aug. 9, 2012 (CN) 201210283260.5

(51) Int. Cl. G06T 11/60; G06F 17/24; G06T 13/80; G06F 17/21

(52) U.S. Cl. CPC G06T 11/60; G06F 17/212; G06F 17/24; G06T 13/80

(57) ABSTRACT

The present invention discloses a kind of method for displaying images dynamically after converting gif images to PDF documents. Wherein, it comprises the following steps: Step S1: extracting all frames of the gif images, and then inserting them into the PDF documents; Step S2: controlling the process of displaying each frame by JavaScript, so as to implement the animated display function of the gif images.

By the above method, said gif images can be displayed dynamically in PDF files, and the entire contents of the gif images can be displayed like animation, which retain the original expressive ability of the gif images, and make the information transmission capability of the PDF files stronger.

### TECHNICAL FIELD

The present invention relates to a method for displaying multiple images dynamically, in particular, which is related to the method for displaying multiple images dynamically after converting gif images to the PDF documents.

### BACKGROUND OF THE TECHNOLOGY

One feature of the gif format is that it can store multiple color images in one file, if the data of multiple images is read out frame by frame, and displayed on the screen to construct the simple animation. Thus that is the dynamical gif images.

So far, after converting dynamic gif images to the PDF format documents, there is only one static picture left in the PDF file (usually it is the first frame), other frames of pictures are lost, and it can not be displayed dynamically like the original gif images.

So, how to solve the problem of only displaying a static picture after converting the gif images to the PDF documents is where the research direction of the field technician is.

### SUMMARY OF THE INVENTION

The main object of the present invention is to provide a method for displaying multiple images dynamically after converting gif images to the PDF documents. Wherein it can make gif images displayed dynamically in PDF files, and also display the whole content of said gif images as same as the animations.

In order to implement the above object, the present invention provides a kind of method for displaying images dynamically after converting gif images to PDF documents. Wherein, it comprises the following steps:

Step S1: extracting all frames of the gif images, and then inserting them into the PDF documents;

Step S2: controlling the process of displaying each frame by JavaScript, so as to implement the animated display function of the gif images.

Wherein, in step S1, a plurality of pictures are inserted in the same page of the PDF file, and to be set the same position coordinates.

Wherein the step S2 comprises the sub step:

Step S21: All the pictures are set in the hiding status by the OC dictionary items of the picture objects;

Step S22: When said page content needs to be rendered, said OC dictionary item of each picture is modified by the JavaScript script to control the status of displaying or hiding;

Step S23: refreshing the current page according to the refreshing rate of each frame of the gif images.

Wherein, in step S1, creating a screen label in PDF files and each frame of the gif images is extracted to be inserted into the same page of the PDF file, as the content stream of said screen label.

Wherein the step S2 comprises the sub steps:

Step S21′: When said page content needs to be rendered, the contents of the labeled AP dictionary items are set as the displaying the image stream according to the refresh rate of each frame of the gif images by JavaScript script.

Step S22′: Refreshing said screen label.

Compared with the prior art, the beneficial effects of the present invention is:

The method of the present invention can make the gif images can be displayed dynamically in PDF files, and the entire contents of the gif images can be displayed as animation, which retain the original expressive ability of the gif images, and make the information transmission capability of the PDF files stronger.

### BRIEF DESCRIPTION OF THE DRAWINGS

In order to illustrate the technical proposal of implementations of the present invention or existing technology clearly, With reference to said accompanying drawings, the description of the implementations of the present invention or existing technology are given as following. Obviously, the given accompanying drawings are not only implementations of the present invention, so that, the ordinary technicians in this field could get other accompanying drawings in accordance with said accompanying drawings without devoting a creative work.

FIG. 1 is a flow diagram of said method for displaying images dynamically after converting gif images to the PDF documents.

FIG. 2 is a flow diagram of one embodiment of said method for displaying images dynamically after converting gif images to the PDF documents.

FIG. 3 is the flow diagram of another embodiment of said method for displaying images dynamically after converting gif images to the PDF documents.

### DETAILED DESCRIPTION OF THE EMBODIMENTS

With reference to said accompanying drawings, the description of the technical proposal of implementations of the present invention is given clearly and integrality as following. The given implementations are only part of the implementations to the present invention, but not entire implementations.

Based on the implementations of the present invention, all of the other implementations which get without devoting a creative work by the ordinary technicians in this field should be deemed to be within the scope of the present invention.

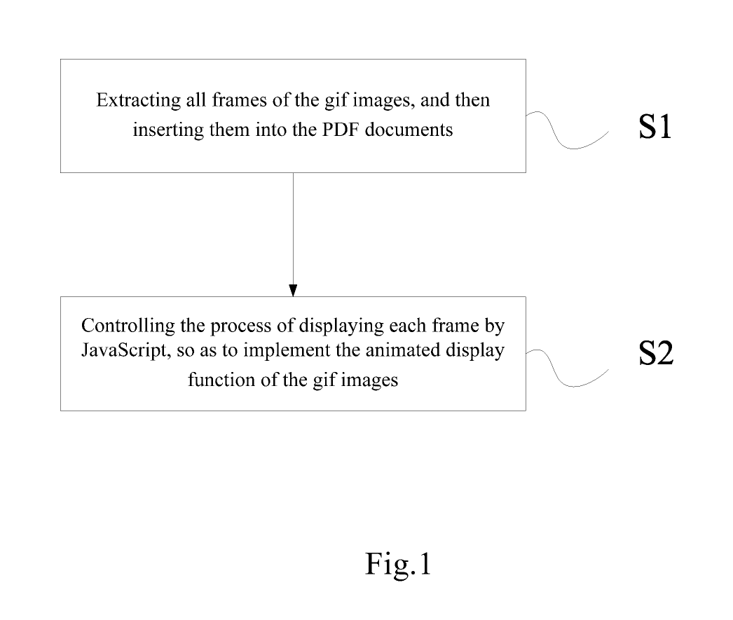

Shown in FIG. 1, is a flow diagram of said method for displaying images dynamically after converting gif images to the PDF documents. Said method for displaying image dynamically after converting gif images to the PDF documents of the present invention comprises the following steps:

Step S1: extracting all frames of the gif images, and then inserting them into the PDF documents;

Step S2: controlling the process of displaying each frame by JavaScript, so as to implement the animated display function of the gif images.

There are two embodiments of methods for displaying images dynamically after converting gif images to the PDF documents. The following will give detailed introduction.

### Embodiment I

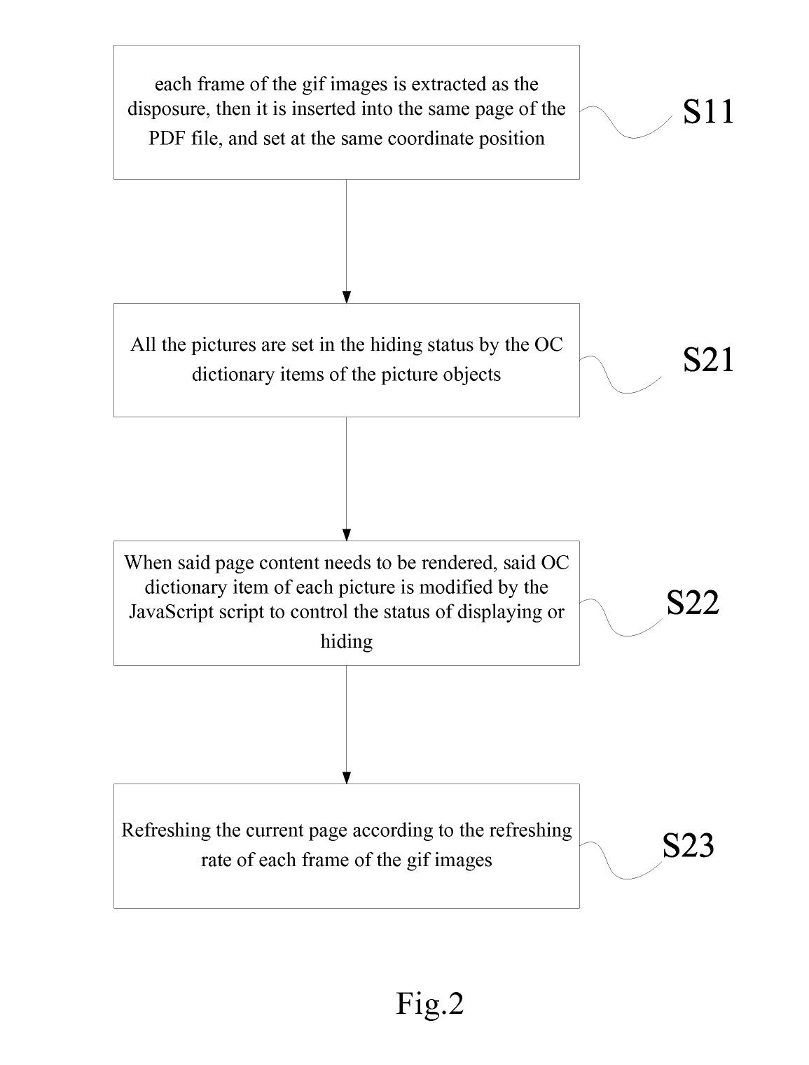

Refer to FIG. 2, which is a flow diagram of one embodiment of said method for displaying images dynamically after converting gif images to the PDF documents, wherein, it comprises the following steps:

Step S11: each frame of the gif images is extracted as the disposure, then it is inserted into the same page of the PDF file, and set at the same coordinate position; thus these images will be displayed at the same place for the above setting, so far, the displayed images at this point is of the nestification image of the above images. Therefore, it needs to control the display of each frame picture.

Step S21: All the pictures are set in the hiding status by the OC dictionary items of the picture objects;

Step S22: When said page content needs to be rendered, said OC dictionary item of each picture is modified by the JavaScript script to control the status of displaying or hiding;

Step S23: refreshing the current page according to the refreshing rate of each frame of the gif images.

By the implementation of the above steps, the contents of each frame can be displayed dynamically just as the original gif images in the PDF file.

### Embodiment II

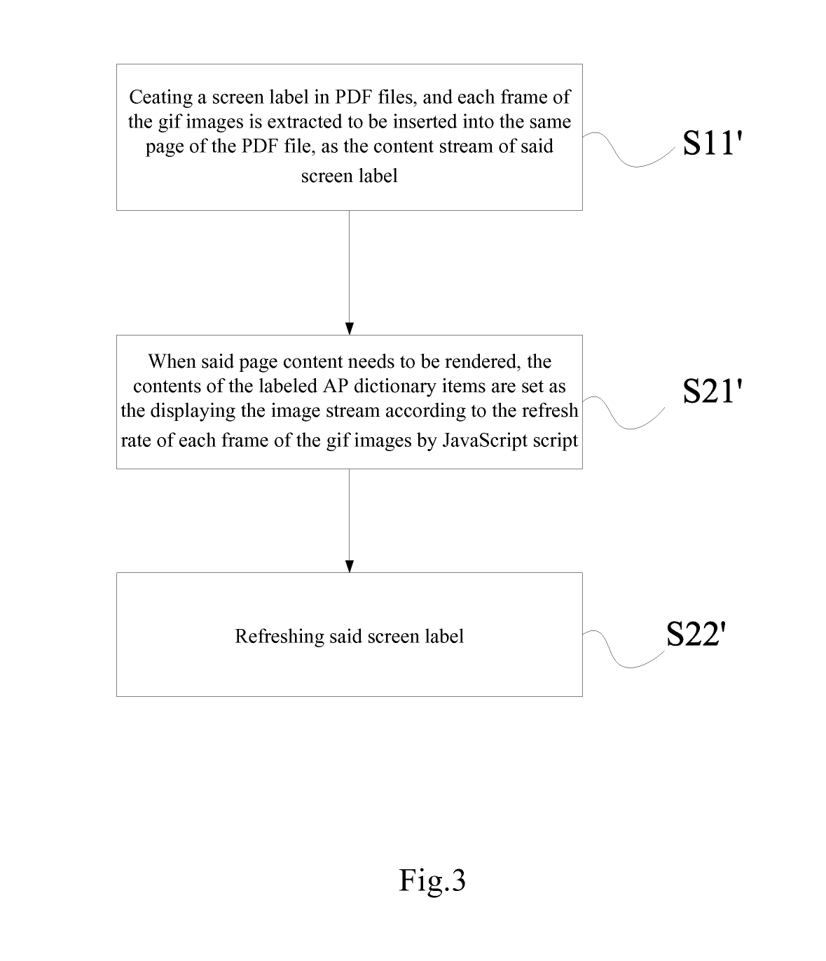

Refer to FIG. 3, which is one flow diagram of an embodiment of said method for displaying images dynamically after converting gif images to the PDF document, wherein, it comprises the following steps:

In step S11′, creating a screen label in PDF files, and each frame of the gif images is extracted to be inserted into the same page of the PDF file, as the content stream of said screen label.

Step S21′: When said page content needs to be rendered, the contents of the labeled AP dictionary items are set as the displaying the image stream according to the refresh rate of each frame of the gif images by JavaScript script.

Step S22′: Refreshing said screen label.

By the implementation of the above steps, the contents of each frame can be displayed dynamically just as the original gif images in the PDF file.

Two above embodiments may both implement the dynamical display images after converting gif images to the PDF documents, wherein, there are the following similarities and differences:

Common: all frames of the gif images are extracted, and inserted into the PDF file, then it implement the animated display function of the gif images by controlling the process of displaying each image frame by JavaScript.

Different points: Embodiment I is to take all extracted pictures as ordinary image objects to be inserted into the same page of the PDF file, then control displaying or hiding of the pictures by the OC dictionary items, and to refresh the page with some frequency.

Embodiment II is that the extracted pictures as a label content stream to be stored in PDF file, by modifying the labeled AP dictionary items to control which frame picture will be displayed, it need to refresh the labeled displaying content in the certain frequency.

Compared with the prior art, the beneficial effects of the present invention is:

The method of the present invention makes that said gif images can be displayed dynamically in PDF files, and the entire contents of the gif images can be displayed like animation, which retain the original expressive ability of the gif images, and make the information transinformation capability of the PDF files stronger.

Finally, it should be noted that: the above embodiments are merely to illustrate the technical proposal of the present invention, but not intended to limit; despite the reference to the aforementioned embodiments of the present invention has been described in detail, those skilled in the art should understand: it is still possible that the technical solution described in the foregoing embodiment is modified, or some technical features are replaced in equivalent; while these modifications or replacements do not essentially corresponding technical solutions departing from the spirit and scope of the invention to implement technical solutions.

1. A method for displaying images dynamically after converting gif images to the PDF documents, characterized in, it comprises the following steps:
Step S1: extracting all frames of the gif images, and then inserting them into the PDF documents;
Step S2: controlling the process of displaying each frame by JavaScript, so as to implement the animated display function of the gif images.

2. Said method for displaying images dynamically after converting gif images to the PDF documents according to claim 1, characterized in that, in step S1, a plurality of images are inserted in the same page of the PDF file, and be set in the same position coordinates.

3. Said method for displaying images dynamically after converting gif images to the PDF documents according to claim 2, characterized in that, in step S2, it comprises the following sub step:
Step S21: All the images are set in the hiding status by the OC dictionary items of the images objects;
Step S22: When said page content needs to be rendered, said OC dictionary item of each image is modified by the JavaScript script to control the status of displaying or hiding;
Step S23: refreshing the current page according to the refreshing rate of each frame of the gif images.

4. Said method for displaying images dynamically after converting gif images to the PDF documents according to claim 1, characterized in that, in step S1, creating a screen label in PDF files, and each frame of the gif images is extracted and inserted into the same page of the PDF file, as the content stream of said screen label.

5. Said method for displaying images dynamically after converting gif images to the PDF documents according to claim 4, characterized in that, in step S2, it comprises the following sub step:
Step S21′: When said page content needs to be rendered, the contents of the labeled AP dictionary items are set as the displaying picture stream according to the refresh rate of each frame of the gif images by JavaScript script.
Step S22′: Refreshing said screen label.
